(19) United States
(12) Patent Application Publication
(10) Pub. No.: US 2005/0029102 A1
(43) Pub. Date: Feb. 10, 2005

(54) Sensor for determining the carbon monoxide concentration of a gas mixture

(76) Inventors: Norbert Breuer, Ditzingen (DE); Ian Faye, Stuttgart (DE); Christian Schiller, Leinfelden-Echterdingen (DE)

Correspondence Address: Striker Striker & Stenby, 103 East Neck Road, Huntington, NY, 11743, US

(21) Appl. No.: 10/491,255

(22) PCT Filed: Oct. 2, 2002
(86) PCT No.: PCT/DE02/03742

(30) Foreign Application Priority Data
Oct. 4, 2001 (DE) 101 48 855.6

(51) Int. Cl. G01N 27/26

(52) U.S. Cl. 204/431; 204/406

(57) ABSTRACT

A sensor (1) for ascertaining a carbon monoxide concentration of a gas mixture (2), having a proton-conducting electrolyte (4) disposed between at least two electrochemically active electrodes (5, 6), in particular catalytically active electrodes (5, 6), of which at least one electrode is CO-sensitive, and in which a measurement unit (8) for measuring at least a first, electrical operating parameter of the sensor (1) at at least one electrode (5, 6) of the sensor (1) is provided, is proposed, with which calibration intervals are markedly lengthened and cross-sensitivities are minimized. This is attained according to the invention in that an evaluation unit (8) is provided for evaluating a change over time in the first, electrical operating parameter of the sensor (1) as a function of a known change over time of at least one second operating parameter.

The invention relates to a sensor for ascertaining a carbon monoxide concentration of a gas mixture as generically defined by preamble to claim 1.

### PRIOR ART

Various types of sensor for detecting carbon monoxide are currently used, such as quartz oscillators and resistive or color-selective sensors. Furthermore, so-called SPE sensors (solid polymer electrolyte sensors) are already being tested as prototypes. Such SPE sensors generally have two electrodes, one electrolyte, and a cell housing. One of these electrodes serves as a cathode, at which a substance is electrochemically reduced, while the other correspondingly acts as the anode and electrochemically oxidizes a second compound.

Between the electrodes, there is an electrolyte or a membrane, which is an electrical insulator for averting a short circuit but which at the same time enables ion (proton) conduction. The cell housing serves not only to seal off the sensor but also to conduct current and acts as a distributor structure for the various gases.

For instance, European Patent Disclosure EP 911 898 A1 discloses an SPE sensor for determining the carbon monoxide concentration in reformate gases of fuel cell units; the oxidation current at the anode decreases as a function of the particular carbon monoxide concentration. Via prior calibration, a carbon monoxide concentration is allocated to the applicable measured current.

Comparable SPE sensors are also known which for instance in the absence of hydrogen directly ascertain the oxidation of carbon monoxide or other process gases potentiostatically. Among other elements, a solid electrolyte and two or three electrodes, the latter if a reference electrode is integrated, are used.

Corresponding CO sensors are used above all as air quality sensors in interiors, for instance in airplanes, homes or the like, and to ascertain the CO concentration of the hydrogen-containing anode gas of a fuel cell.

Fuel cells used at present exhibit poisoning of the anode catalyst in the presence of carbon monoxide in the hydrogen-rich anode gas. Typical limit values for carbon monoxide to prevent this poisoning, depending on the electrode catalyst, are around 10 ppm (for platinum catalysts) to 100 ppm (for platinum-ruthenium catalysts).

Above all when the anode gas is generated from liquid or gaseous hydrocarbon-containing educts by reformation, a not inconsiderable quantity of carbon monoxide in the reformate occurs, whose concentration must be lowered to the limit values described above by post-cleaning. Exact monitoring and regulation of the proportion of carbon monoxide in the anode gas stream with the aid of suitable CO sensors is indispensable for malfunction-free operation of corresponding fuel cells.

Especially for the applications listed above, in CO sensors used thus far the comparatively short calibration intervals as well as relatively pronounced cross-sensitivities are disadvantageous.

### OBJECT AND ADVANTAGES OF THE INVENTION

By comparison, it is the object of the invention to propose a sensor for ascertaining a carbon monoxide concentration of a gas mixture, having a proton-conducting electrolyte disposed between at least two electrochemically active electrodes, where one of the electrodes is carbon monoxide-sensitive, with which sensor calibration intervals are markedly lengthened and cross-sensitivities are minimized.

This object, taking prior art as defined at the outset as the point of departure, is attained by means of the definitive characteristics of claim 1.

By the provisions recited in the dependent claims, advantageous embodiments and refinements of the invention are possible.

Accordingly, a sensor of the invention is distinguished in that an evaluation unit is provided for evaluating a change over time in the first, electrical operating parameter of the sensor as a function of a known change over time of at least one second operating parameter, in particular of the sensor and/or a device that changes the carbon monoxide concentration of the gas mixture.

Thus according to the invention, preferably by means of a model of the electrochemical sensor system, or in other words for instance by means of a so-called electrical engineering substitute circuit diagram, the corresponding electronic components, such as resistors, inductive resistors and capacitors, which correlate with electrochemical processes in the overall electrochemical system, can be determined, so that above all the internal status of the sensor can also be ascertained. This advantageously makes it possible for changes for instance in the electrolyte resistance, the activity of the catalyst or the electrode, or mass transfer to be evaluated independently from one another.

The result, via a family of characteristics acting as a so-called null point for the individual elements of the substitute circuit diagram, is advantageously characteristic values under standard conditions, that is, generally in the absence of carbon monoxide. A deviation from these values can be ascribed to various causes, so that not only is it possible to identify the carbon monoxide concentration of the gas mixture but also, and advantageously as noted above, the internal status of the sensor and thus the effects of aging and/or other kinds of functional problems of the sensor can be identified with the evaluation unit of the invention. In general, a quantitative determination of the carbon monoxide content or of the applicable operating parameter can be done by way of a prior calibration of the sensor.

Advantageously, as a function of the operating state of the reformer of the carbon monoxide source, the change in the first operating parameter of the sensor is evaluated to ascertain or measure the known change over time in the second operating parameter. For instance, a distinction is made between phases that generate comparatively much or little carbon monoxide or hydrogen-containing reformate or the like. These phases can optionally be ascertained by means of direct measurement of an applicable operating parameter of the carbon monoxide source or reformer, or with the support of a suitable model. In the latter case, corresponding measurements are optionally supplemented with numerical calculations.

In principle, the carbon monoxide sensor according to the invention assures markedly enhanced measurement accuracy, since the breadth of information here, is substantially more-detailed than if only sensor current or voltage is detected as in the prior art. Above all measurement inaccuracies resulting from a change in the sensor, such as from aging, poisoning or the like, and the frequency of regular calibration intervals can be reduced decisively. The service life of the sensor according to the invention is at the same time lengthened markedly.

In fuel cell systems with at least one reformer for generating the gas mixture or reformate, one or more cleaning stages for cleaning the gas mixture, and a fuel cell unit for generating electrical energy, which are subject in particular to frequent load alternations, as in automotive applications or the like, a second operating parameter of the fuel cell system is optionally and advantageously monitored or determined by means of the evaluation unit, an example of this second operating parameter being the so-called load resistance and/or the operating state of the reformer or the like, and the change in the first operating parameter of the sensor is advantageously evaluated. In this case, the value or course of the change over time of the second operating parameter, such as the change in the load resistance, can be ascertained comparatively simply. A corresponding change can optionally be achieved by actuating an actuating element, for instance in the form of a “gas pedal” in a vehicle or the like.

In a particular embodiment of the invention, a generator for generating a known change over time of the second operating parameter, in particular of the sensor and/or the carbon monoxide source, is provided. This assures that in all operating states of the sensor, that is, including in static use, the internal operating parameters of the sensor can be monitored. Advantageously, not only a comparatively slight and/or continuous or long-lasting but also a comparatively major and/or pulselike change in the second operating parameter, in particular of the sensor and/or the carbon monoxide source, can be achieved.

Advantageously, the second operating parameter of the sensor and/or the carbon monoxide source is likewise an electrical operating parameter, such as the operating voltage, operating current, or the like. The change preferably brought about by the generator is comparatively slight, so that the operation of the sensor is not adversely affected. With this provision, electrical monitoring of the gas mixture for its CO concentration is advantageously assured by means of the sensor of the invention.

In a further embodiment of the invention, the second operating parameter, in particular of the sensor and/or the reformer, or corresponding cleaning stages for CO cleaning of the reformate gas of a fuel cell unit, is a nonelectrical operating parameter, such as the pressure, temperature, humidity, or composition of the gas mixture and/or of the reformer, or corresponding cleaning stages for CO cleaning of the reformate gas.

Preferably, the known change over time of at least the second operating parameter of the sensor and/or of the CO source takes place in staggered fashion to an ensuing measurement phase of the first operating parameter of the sensor, or alternatively simultaneously with it. This latter means that the known change over time of an operating parameter, such as an alternating voltage at a known frequency, is optionally modulated to the corresponding operating parameter, such as the operating voltage.

In a special refinement of the invention, the evaluation unit is embodied for comparing the change over time in the first, electrical operating parameter of the sensor with a set-point change in the first, electrical operating parameter of the sensor. As a result, diagnosis of the internal operating state of the sensor can advantageously be made.

Preferably, the evaluation unit includes at least one electrical filter device for separating the change, caused by the change in the second operating parameter, in the first, electrical operating parameter of the sensor from changes in other operating parameters. In periodic changes, this filter can for instance be embodied as a lock-in amplifier. This advantageously assures that the change in the first operating parameter, which is caused by the known change over time in the second operating parameter, in particular of the sensor, can be ascertained. Thus in particular by means of the filter device, the discrimination between signal and noise is markedly improved.

According to the invention, a pressure oscillation of an educt stream, for example, with a defined frequency spectrum can optionally be filtered out of the current or voltage signal of the sensor by means of a lock-in amplification; for the further evaluation, advantageously only the frequencies of the measurement signal, such as the pressure oscillation, are then used.

Preferably, the evaluation unit includes a plotting unit for plotting the course over time of at least one operating parameter, so that for instance by means of a family of characteristics stored in memory, an integrated expert system, or the like, an advantageous monitoring and diagnosis of the sensor can be achieved.

In a special refinement of the invention, the evaluation unit includes a device for external display of the operating state of the sensor, for instance for displaying the operating state for the user or for the technical monitoring staff. Among other things, maintenance and repair of a sensor of the invention are advantageously improved, since they can log and plot the course of the operating parameters for this intended use.

Optionally, from the course over time of the operating parameters or the operating state, conclusions pertaining to possible defective or worn components of the sensor or the gas generating components can be made, such as the reformer or cleaning stages and/or corresponding devices for ventilating interiors.

In general, the catalyst on the anode side, or the catalytically active anode, is cleaned at specified or regular intervals, to assure problem-free functioning of the sensor over a relatively long time. This can be done in particular by briefly changing the sensor current or voltage. As a consequence of this change, carbon monoxide in particular is oxidized on the catalyst or anode and desorbed by the catalyst, thereby putting the sensor back into quasi-“unpoisoned” condition. According to the invention, ascertaining the degree of poisoning of the anode and the detoxification that may as a result be necessary are possible by means of a suitable evaluation unit.

### EXEMPLARY EMBODIMENT

One exemplary embodiment of the invention is shown in the drawing and will be described in further detail below in conjunction with the drawings.

Individually, the drawings show:

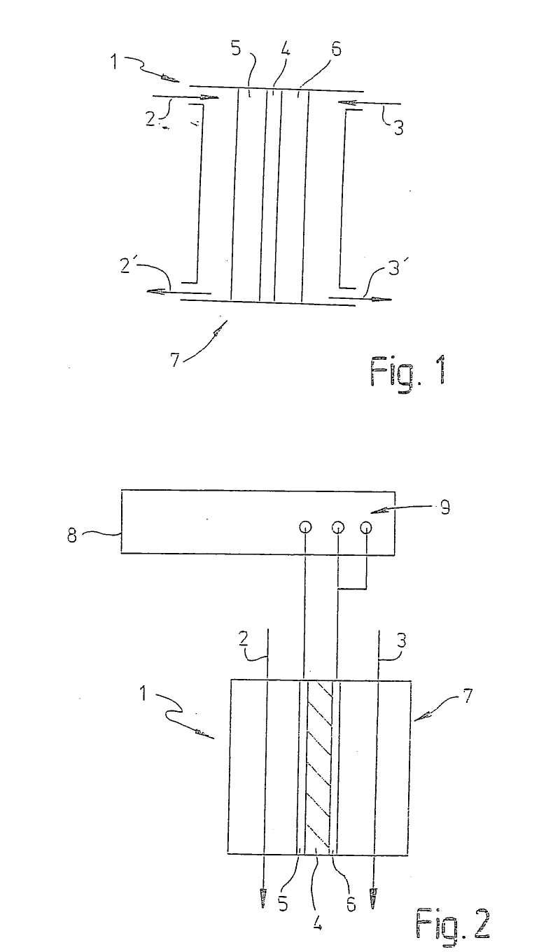

FIG. 1, a schematic illustration of a sensor of the invention without an evaluation unit; and

FIG. 2, a schematic illustration of a sensor of the invention, with an evaluation unit.

In FIG. 1, a construction of a CO sensor 1 of the invention is shown schematically. The sensor 1 has a flow through it of both the gas mixture stream 2 to be investigated and an operating gas stream 3. The gas mixture stream 2 to be investigated flows through the sensor 1 on the side of a catalytically active anode 5. The operating gas stream 3, in particular a stream of oxygen or air, flows through the sensor 1 on the side of a cathode 6.

The cathode 6 and anode 5 can each optionally be embodied as a catalytically active coating of a membrane 4. In general, the electrodes, that is, the anode 5 and cathode 6, are each made of an electrochemically active material, and the anode 5 is carbon monoxide-sensitive. The electrode material is selected to be as carbon monoxide-insensitive as possible, so that even upon a comparatively slight change in the carbon monoxide quantities or concentrations in the gas mixture stream 2, this change is detectable in the electrode response. Preferably, the most various metals and alloys are used, especially elements of the 8th Secondary Group, such as platinum or the like.

The sensor 1 further includes a housing 7, so that besides sealing off of the sensor 1, provision is simultaneously made for conducting current and the function of a distributor structure for the gases 2, 3.

In FIG. 2, a sensor 1 with a generator 8 is shown. Here both the gas mixture stream 2 and the operating gas stream 3 flow through the sensor 1, and a proton-conducting membrane 4 is disposed between an anode 5 and a cathode 6.

The generator 8 is embodied as both a frequency generator and a frequency analyzer or evaluation unit in accordance with the invention. The generator 8 preferably has three terminals 9, so that by means of one terminal, a reference measurement of the current or voltage is made possible.

In general, the generator 8 is embodied such that it can optionally superimpose measurement signals of sinusoidal, square or comparable form on the operating signal of the sensor 1 as applicable. Moreover, in a special variant, the generator 8 can also be embodied for so-called Fourier transformation.

Ascertaining the carbon monoxide concentration of the gas mixture stream 2 is done for instance by measuring the current or voltage of the sensor 1. By way of a prior calibration, a defined carbon monoxide concentration is allocated to the particular current or voltage measured. On the basis of sensor signal evaluation according to the invention, cross-sensitivities can be minimized and calibration intervals can be lengthened markedly.

For instance, impedance spectroscopy, as a measurement method according to the invention, can be realized by means of either capacitive coupling or inductive coupling of an impedance measuring instrument. It is known that the frequency-dependent impedance of SPE sensors 1 can be modelled by way of electrotechnical substitute circuit diagrams. The substitute circuit diagram comprises a network of ohmic, capacitive and inductive resistors as well as other complex-value resistors, which for instance describe the mass transfer or the catalyst deactivation. Often, the values of the resistor network are adapted via measurement data of the impedance spectrum, and the values ascertained as a result represent the internal operating state of the sensor 1 as models.

According to the invention, for a plurality of different frequencies, for instance ten of them, an alternating voltage can be superimposed or impressed on the voltage of the sensor 1. The corresponding current response is plotted by means of a current measuring device or the generator 8. The measurement process can either be done sequentially, that is, successively, or also simultaneously, if a suitable filter such as a lock-in amplifier is used, by superposition of the operating signal on the measurement signals.

From the ratio of the current response to the excitation voltage signal, the complex-value impedance can be ascertained for the frequencies selected. By means of the data set thus obtained, the values of the resistor network of the sensor 1 are calculated. Next, these values are interpreted; that is, as a function of the operating state of the sensor 1, the resistance values are within narrow parameter intervals, and exceeding of the parameter limits is an indication of a nonoptimal or defective operating state of the sensor 1, which can be identified as a result.

Optionally with the aid of a matrix of provisions to be defined, appropriate countermeasures can be taken. For instance, if the value that corresponds in the resistor network to the ohmic electrolyte resistance exceeds a certain threshold value, this can be an indication of defective moistening of the membrane. Accordingly, a moistener, not shown, would change the humidity in the educt streams of the sensor 1 as needed. A system which can work with this kind of provision matrix can also be called an “expert system”, which for instance defines an impedance values set as “good”, and if predetermined values are exceeded for the operating parameters initiates appropriate countermeasures.

In principle, the change over time in an electrochemical operating parameter can lead to a frequency-dependent display, via a Fourier transform. Since simultaneously the current or voltage of the system reacts to the change in the electrochemical parameter, the reaction of the system can be analyzed and assessed via a second Fourier transform, by analogy to the above remarks in the frequency space, and as a result the CO concentration of the gas mixture 2 can be ascertained.

The possibility furthermore exists of converting the chronological behavior of the operating parameter being observed directly into a functional description, and using the functional operating parameters obtained from the adaptation of the values of the substitute circuit diagram as a point of departure for an analysis of the operating state of the sensor 1. For instance, it is known that in a potentiostatic voltage jump, the current response in the first few milliseconds is determined by the change in the double-layer capacitance of the sensor 1. Over longer times, the chronological behavior is determined by diffusion processes. If for example upon a voltage jump in the increasing direction in the time range from 50 milliseconds to 1 second an only slight rate of change in the current intensity is ascertained, this is an indication of an obstructed mass transfer, which can for instance be correlated with a carbon monoxide occupation, in the sensor 1.

According to the invention, the sensor 1 can be characterized in terms of its chronological behavior under various load states, and the sets of parameters thus obtained are stored in memory in a database. This assures that during operation, deviations from the ideal state are selected by way of observation of the load alternation behavior.

The ascertained load alternation behavior is compared with the values stored in memory. For instance by way of a comparison with known patterns, that is, so-called “pattern matching”, or by means of a functional analysis, it can be determined whether the ascertained behavior corresponds to a proper state of the sensor 1, or in which direction the operating state has moved away from the set-point state. This procedure is especially advantageous in highly dynamic systems, in which load alternations occur frequently, such as in the reforming of hydrocarbons in a vehicles.

1-8. cancelled.

9. A sensor for ascertaining a carbon monoxide concentration of a gas mixture, comprising at least two electrochemically active electrodes formed as catalytically active electrodes, with one of said electrodes being carbon monoxide-sensitive; a protone-conducting electrolyte disposed between said at least two electrodes; a measurement unit for measuring at least one first, electrical parameter of the sensor at at least one of said electrodes, said measurement unit including an evaluation unit for evaluation a change over time in the first, electrical operating parameter as a function of a known change over time of at least one second operating parameter; and a generator for generating a known change over time of the second operating parameter.

10. A sensor as defined in claim 9, wherein said generator generates the second operating parameter as a non electrical operating parameter.

11. A sensor as defined in claim 9, wherein said generator generates the second operating parameter which is also an electrical operating parameter.

12. A sensor as defined in claim 9, wherein said evaluating unit is formed for comparing the change over time, in the first, electrical operating parameter of the sensor with a set-point change in the first, electrical operating parameter of the sensor.

13. A sensor as defined in claim 9, wherein said evaluation unit includes at least one electrical filter device for separating a change, caused by a change in the second operating parameter, in the first, electrical operating parameter of the sensor from changes in other operating parameters.

14. A sensor as defined in claim 9, wherein said evaluation unit includes a plotting unit for plotting a course over time of the at least one operating parameter.

15. A fuel cell system for generating electrical energy, the fuel cell system comprising a sensor for ascertaining a carbon monoxide concentration of a gas mixture, comprising at least two electrochemically active electrodes formed as catalytically active electrodes, with one of said electrodes being carbon monoxide-sensitive; a protone-conducting electrolyte disposed between said at least two electrodes; a measurement unit for measuring at least one first, electrical parameter of the sensor at at least one of said electrodes, said measurement unit including an evaluation unit for evaluation a change over time in the first, electrical operating parameter as a function of a known change over time of at least one second operating parameter; and a generator for generating a known change over time of the second operating parameter.
